(19) United States
(12) Patent Application Publication
(10) Pub. No.: US 2026/0080834 A1
(43) Pub. Date: Mar. 19, 2026

(54) DISPLAY DEVICE

(71) Applicant: LG Display Co., Ltd., Seoul (KR)

(72) Inventors: Jong Wook JANG, Gyeonggi-do (KR); Ki Tae KWON, Gyeonggi-do (KR); Dae Ho PARK, Gyeonggi-do (KR)

(21) Appl. No.: 19/284,551

(22) Filed: Jul. 29, 2025

(30) Foreign Application Priority Data
Sep. 13, 2024 (KR) 10-2024-0125339

(51) Int. Cl. G09G 3/3266; G09G 3/3275

(52) U.S. Cl. CPC G09G 3/3266; G09G 3/3275; G09G 2310/0289; G09G 2310/0297; G09G 2310/08; G09G 2330/021

(57) ABSTRACT

A display device includes a display panel including a plurality of gate drivers and a plurality of pixels disposed in a matrix form, a plurality of level shifters connected to the plurality of gate drivers, and a timing controller connected to the plurality of level shifters, wherein the plurality of gate drivers may be disposed between the plurality of pixels. The display device adjusts a frame frequency according to each divided driving region.

### CROSS-REFERENCE TO RELATED APPLICATION

Pursuant to 35 U.S.C. § 119(a), this application claims the benefit of an earlier filing date and right of priority to Korean Patent Application No. 10-2024-0125339, filed on Sep. 13, 2024, the disclosure of which is incorporated herein by reference in its entirety.

### TECHNICAL FIELD

The present specification relates to a display device.

### BACKGROUND

A driving circuit of a flat panel display (FPD) device writes pixel data of an input image to pixels of a display panel to reproduce the input image on a pixel array. The driving circuit of the display device includes a data driving circuit which supplies data signals to data lines, a gate driving circuit which supplies gate pulses to gate lines, and a timing controller for controlling the operation timing of the data driving circuit and the gate driving circuit.

### SUMMARY

A display device according to an implementation of the present specification includes a display panel including a plurality of gate drivers and a plurality of pixels disposed in a matrix form, a plurality of level shifters connected to the plurality of gate drivers, and a timing controller connected to the plurality of level shifters, wherein the plurality of gate drivers are disposed between the plurality of pixels.

According to various implementations of the present specification, the display panel may include a display region including a first display region and a second display region, and the plurality of gate drivers may include a first gate driver disposed in the first display region and a second gate driver disposed in the second display region.

According to various implementations of the present specification, a pulse width of a start signal input to the first gate driver may be different from a pulse width of a start signal input to the second gate driver.

According to various implementations of the present specification, a first frame frequency at which the first display region is driven may be different from a second frame frequency at which the second display region is driven.

According to various implementations of the present specification, the plurality of level shifters may include a first level shifter connected to the first gate driver and a second level shifter connected to the second gate driver.

According to various implementations of the present specification, the first level shifter may be connected to the second gate driver, and the second level shifter may be connected to the first gate driver.

According to various implementations of the present specification, the display device may further include a plurality of source drive integrated circuits (ICs) disposed between the plurality of level shifters and the plurality of gate drivers, wherein the plurality of source drive ICs may be respectively connected to the plurality of level shifters and the plurality of gate drivers.

According to various implementations of the present specification, the plurality of source drive ICs may include a first source drive IC disposed between the first level shifter and the first gate driver, and a second source drive IC disposed between the second level shifter and the second gate driver.

According to various implementations of the present specification, the first source drive IC may be connected to the first level shifter and the first gate driver, and the second source drive IC may be connected to the second level shifter and the second gate driver.

According to various implementations of the present specification, the first source drive IC may be connected to the second level shifter, and the second source drive IC may be connected to the first level shifter.

According to various implementations of the present specification, the display device may further include a first multiplexer connected to the first level shifter, the second level shifter, and the first source drive IC, and a second multiplexer connected to the second level shifter, the first level shifter, and the second source drive IC.

According to various implementations of the present specification, the display region may further include a third display region, and the plurality of gate drivers may further include a third gate driver disposed in the third display region.

According to various implementations of the present specification, a first frame frequency at which the first display region is driven, a second frame frequency at which the second display region is driven and a third frame frequency at which the third display region is driven may be all different from each other.

According to various implementations of the present specification, the plurality of level shifters may include a first level shifter connected to the first gate driver, a second level shifter connected to the second gate driver, and a third level shifter connected to the third gate driver.

According to various implementations of the present specification, the first level shifter may be connected to the second gate driver and the third gate driver, the second level shifter may be connected to the first gate driver and the third gate driver, and the third level shifter may be connected to the first gate driver and the second gate driver.

According to various implementations of the present specification, the display device may further include a plurality of source drive ICs disposed between the plurality of level shifters and the plurality of gate drivers, wherein the plurality of source drive ICs may be respectively connected to the plurality of level shifters and the plurality of gate drivers.

According to various implementations of the present specification, the plurality of source drive ICs may include a first source drive IC disposed between the first level shifter and the first gate driver, a second source drive IC disposed between the second level shifter and the second gate driver, and a third source drive IC disposed between the third level shifter and the third gate driver.

According to various implementations of the present specification, the first source drive IC may be connected to the first level shifter and the first gate driver, the second source drive IC may be connected to the second level shifter and the second gate driver, and the third source drive IC may be connected to the third level shifter and the third gate driver.

According to various implementations of the present specification, the first source drive IC may be connected to the second level shifter and the third level shifter, the second source drive IC may be connected to the first level shifter and the third level shifter, and the third source drive IC may be connected to the first level shifter and the second level shifter.

According to various implementations of the present specification, the display device may further include a first multiplexer connected to the first level shifter, the second level shifter, the third level shifter, and the first source drive IC, a second multiplexer connected to the second level shifter, the first level shifter, the third level shifter, and the second source drive IC, and a third multiplexer connected to the third level shifter, the first level shifter, the second level shifter, and the third source drive IC.

### BRIEF DESCRIPTION OF THE DRAWINGS

The following drawings attached to this specification illustrate preferred implementations of the present specification and, together with the detailed description in the specification to be described below, serve to further understand the technical idea of the present specification, and therefore the present specification should not be construed as being limited to matters described in such drawings.

FIG. 1 is a block diagram showing a display device according to an implementation of the present specification.

FIG. 2 is a block diagram showing a display device according to another implementation of the present specification.

FIG. 3 is a waveform diagram showing a timing signal synchronized with an image signal.

FIG. 4 is a circuit diagram showing a pixel circuit according to the implementation of the present specification.

FIG. 5 is a circuit diagram showing a pixel circuit according to another implementation of the present specification.

FIGS. 6 to 8 are views showing various implementations of a level shifter in the display device according to the implementation of the present specification.

FIG. 9 is a view schematically showing a gate driver which outputs gate signals.

FIG. 10 is a view showing a gate driver which outputs gate signals applied to the pixel circuit.

FIG. 11 is a circuit diagram schematically showing a shift register of a gate driver.

FIG. 12 is a circuit diagram showing a circuit of a stage according to the implementation of the present specification.

FIG. 13 is a waveform diagram showing input/output waveforms of the circuit of the stage according to the implementation of the present specification.

FIG. 14 is a circuit diagram showing one channel of the level shifter.

FIG. 15 is a circuit diagram showing a channel of the level shifter.

FIG. 16 is a waveform diagram showing input/output signals of the level shifter.

FIG. 17 is a block diagram showing the display device including the level shifter.

FIG. 18 is a block diagram showing a display device according to a first implementation of the present specification.

FIG. 19 is a block diagram showing a display device according to a second implementation of the present specification.

FIG. 20 is a waveform diagram showing exemplary input/output signals of a level shifter included in the display device according to the second implementation.

FIG. 21 is a waveform diagram showing exemplary output signals of the level shifter included in the display device according to the second implementation.

FIG. 22 is a block diagram showing a display device according to a third implementation of the present specification.

FIG. 23 is a block diagram showing a transmission path of a signal in the display device according to the third implementation of the present specification.

FIG. 24 is a block diagram showing a display device according to a fourth implementation of the present specification.

FIG. 25 is a waveform diagram showing exemplary multiplexer control and output signals of the present specification.

FIG. 26 is a view showing an example in which the display device according to the implementation of the present specification is applied to an infotainment system of a vehicle.

FIG. 27 is a waveform diagram showing a frame frequency for each display region.

### DETAILED DESCRIPTION

A display device can implement a timing controller that controls outputs of the data driving circuit and the gate driving circuit. The timing controller generates a clock signal which controls the gate driving circuit. A level shifter generates a clock in response to a clock input from the timing controller. The gate driving circuit sequentially outputs gate pulses using a shift register that receives the clock as input.

As information devices adopt larger displays, multi-tasking becomes possible by running two or more applications or contents, and a large amount of information may be simultaneously displayed on the screen. It may be necessary to display different images on the screen or control frame frequencies of the images differently. In this case, the output of the gate driving circuit needs to be independently controlled for each region in the screen. In this case, there is a problem in that the gate driving circuit becomes larger and a control circuit thereof becomes complicated. Implementations are disclosed herein that can address one or more of the above challenges.

Advantages and features of the present specification disclosed in the present specification, and methods of achieving them will become apparent with reference to the following implementations, which are described in detail, in conjunction with the accompanying drawings. The present specification is not limited to the implementations to be described below and may be implemented in different forms, the implementations are only provided to completely disclose the present specification and completely convey the scope of the present specification to those skilled in the art, and the present specification is defined by the disclosed claims.

In describing the present specification, when it is determined that a detailed description of related known technology may unnecessarily obscure the gist of the present specification, the detailed description thereof will be omitted.

When ‘providing,’ ‘may include,’ ‘having,’ ‘consisting of,’ and the like mentioned in the present specification are used, other parts may be added unless ‘only’ is used. A case in which a component is expressed in a singular form may also be interpreted as a plural form unless explicitly stated otherwise.

When a position relationship and an interconnection relationship between two components such as ‘on,’ ‘at an upper portion,’ ‘at a lower portion,’ ‘next to,’ ‘connect or couple,’ ‘crossing or intersecting,’ or the like are described, one or more other components may be interposed between the components unless there is a mention such as ‘immediately’ or ‘directly.’

When a temporal relationship such as ‘after,’ ‘following,’ ‘next,’ ‘before,’, and the like is described, the temporal relationship may not be continuous on a time axis unless ‘immediately’ or ‘directly’ is used.

First, second, and the like may be used to distinguish components, but the functions or structures of these components are not limited by ordinal numbers in front of the components or component names.

The following implementations may be partially or fully combined with each other, and technically, various types of interconnection and driving are possible. The implementations may be implemented independently of each other or may be implemented together in an associated relationship.

Terms (including technical and scientific terms) used in the implementations of the present specification may be interpreted as meanings which may be generally understood by those skilled in the art unless explicitly specifically defined and described, and meanings of commonly used terms such as terms defined in a dictionary may be interpreted in consideration of contextual meanings of the related technology.

In a display device according to the present specification, a pixel circuit and a gate driving circuit may include a plurality of transistors. The transistor may be an oxide thin film transistor (TFT) including an oxide semiconductor or a low temperature poly silicon (LTPS) TFT including LTPS.

The transistor is a three-electrode element including a gate, a source, and a drain. The source is an electrode which supplies carriers to the transistor. In the transistor, the carriers start to flow from the source. The drain is an electrode through which the carriers exit the transistor. In the transistor, the carriers flow from the source to the drain.

In the case of an n-channel transistor, since the carriers are electrons, a source voltage is lower than a drain voltage so that electrons may flow from the source to the drain. In the n-channel transistor, current flows in a direction from the drain to the source. In the case of a p-channel transistor, since the carriers are holes, the source voltage is higher than the drain voltage so that holes may flow from the source to the drain. In the p-channel transistor, since holes flow from the source to the drain, current flows from the source to the drain. It should be noted that the source and drain of the transistor are not fixed. For example, the source and drain may be changed depending on the applied voltage. Accordingly, the present disclosure is not limited by the source and drain of the transistor. In the following description, the source and drain of the transistor will be referred to as first and second electrodes.

A gate signal may swing between a gate on voltage and a gate off voltage. The transistor is turned on in response to the gate on voltage, but is turned off in response to the gate off voltage. In the case of the n-channel transistor, the gate on voltage may be a gate high voltage VGH, and the gate off voltage may be a gate low voltage VGL. In the case of the p-channel transistor, the gate on voltage may be the gate low voltage VGL, and the gate off voltage may be the gate high voltage VGH.

Hereinafter, implementations of the present disclosure will be described in detail with reference to the accompanying drawings.

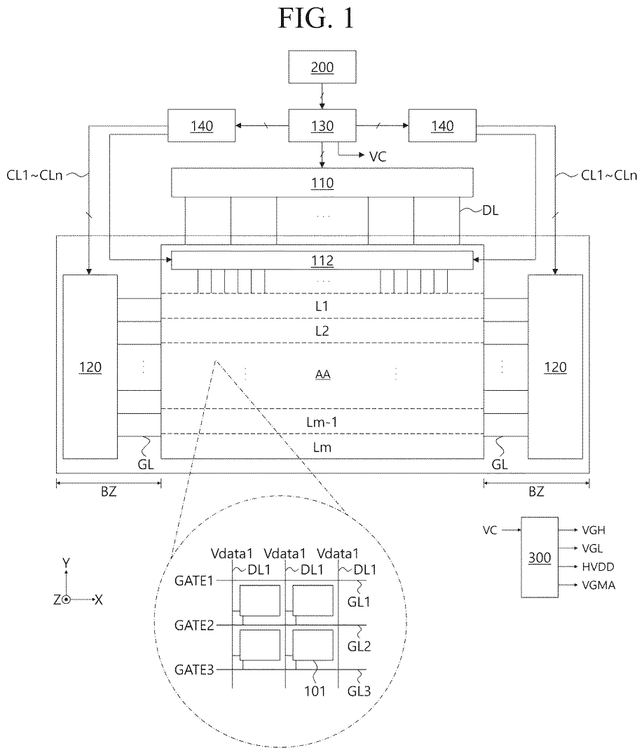

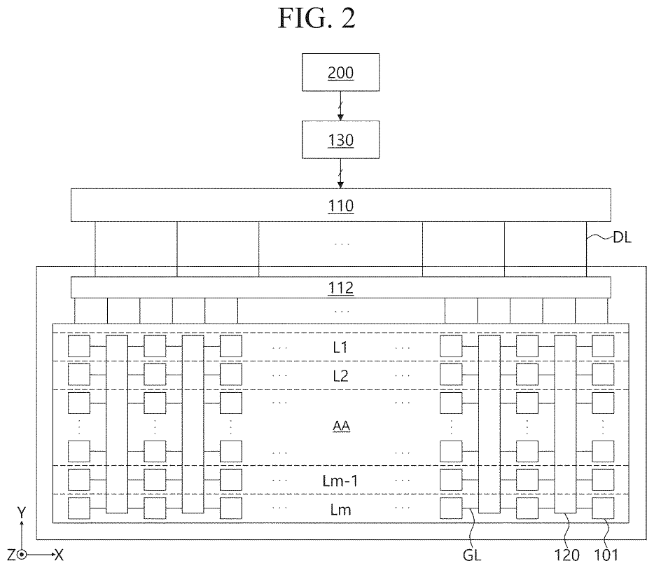

FIG. 1 is a block diagram showing a display device according to an implementation of the present specification. FIG. 2 is a block diagram showing a display device according to another implementation of the present specification.

Referring to FIGS. 1 and 2, the display device according to the implementation of the present disclosure may include a display panel 100 and a display panel driving circuit.

A screen of the display panel 100 may include a pixel array AA which displays pixel data of an input image. The pixel data of the input image may be displayed in pixels of the pixel array AA. The pixel array AA may include a plurality of data lines DL, a plurality of gate lines GL intersecting the data lines DL, and pixels disposed in a matrix form. Instead of or in addition to the matrix form, the arrangement of the pixels may be formed in various forms, such as a form which shares pixels which emit light of the same color, a stripe form, a diamond form, and the like in addition to the matrix form.

When a resolution of the pixel array AA is n*m, the pixel array AA may include n pixel columns and m pixel lines L1 to Lm intersecting the pixel columns. The pixel line may include pixels disposed in a first direction (for example, an X-axis direction). The pixel column may include the pixels disposed in the first direction (for example, the X-axis direction). One horizontal period 1H is a time acquired by dividing one frame period by the m pixel lines L1 to Lm. The pixel data may be written to pixels of one pixel line in one horizontal period 1H.

Each of the pixels may include two or more subpixels 101 to implement colors. For example, each of the pixels may be divided into a red subpixel, a green subpixel, and a blue subpixel. Each of the pixels may further include a white subpixel. Each of the subpixels 101 may include a pixel circuit. The pixel circuit may include a pixel electrode, one or more thin film transistors TFT, and a capacitor. The pixel circuit may be connected to data lines DL and gate lines GL.

There may be differences in the electrical characteristics of driving elements between pixels due to process deviations and element characteristic deviations caused by the manufacturing process of the display panel. The differences in the electrical characteristics of the driving elements may become larger as a driving time of the pixels elapses. In order to compensate for the electrical characteristic deviations of the driving elements between the pixels, internal compensation technology or external compensation technology may be applied.

Touch sensors may be disposed on the display panel 100 to implement a touch screen. A touch input may be sensed using separate touch sensors or may be sensed through the pixels. The touch sensors may be implemented as on-cell type or add on type sensors disposed on a screen of a display panel or in-cell type touch sensors built in the pixel array.

The display panel driving circuit may write data of the input image to the pixels of the display panel 100 under control of a timing controller 130. The display panel driving circuit may include a data driver 110, a gate driver 120, the timing controller 130 for controlling the operation timing of the drivers 110 and 120, and a level shifter 140 connected between the timing controller 130 and the gate driver 120. The display panel driving circuit may further include a power supply unit 300.

The data driver 110 may convert the pixel data of the input image received as a digital signal from the timing controller 130 for every frame into an analog gamma compensation voltage and output data signals Vdata1 to Vdata3. As shown in a circle in FIG. 1, first to third data signals Vdata1 to Vdata3 output from the data driver 110 may be supplied to the corresponding first to third data lines DL1 to DL3. The data driver 110 may output the data signals Vdata1 to Vdata3 using a digital to analog converter (hereinafter, referred to as “DAC”) which converts the digital signal into the analog gamma compensation voltage. The data driver 110 may be integrated into a source drive integrated circuit (IC). The source drive IC may be mounted on a flexible film and connected between a source printed circuit board (PCB) and the display panel 100 in a chip on film (COF) bonding process. A touch sensor driver for driving the touch sensors may be built in each of the source drive ICs.

The display panel driving circuit may further include a demultiplexer array 112 disposed between the data driver 110 and the data lines DL.

As the demultiplexer array 112 sequentially connects one channel of the data driver 110 to the plurality of data lines DL to distribute a data signal output from one channel of the data driver 110 to the data lines DL in a time-division manner, the number of channels of the data driver 110 may be reduced.

The gate driver 120 may be formed in a bezel region BZ where no image is displayed on the display panel 100, or at least a portion of the gate driver 120 may be disposed in the pixel array AA (see FIG. 2). When at least a portion of the gate driver 120 is disposed in the pixel array AA, the gate driver 120 may be disposed in the pixel array AA along with the pixel circuit. The gate driver 120 may sequentially output the gate signal to the gate lines GL under control of the timing controller 130. The gate driver 120 may sequentially supply the gate signal to the gate lines GL by shifting the gate signal using a shift register. Since the gate driver 120 is built in the pixel array AA where the input image is reproduced, left and right bezel regions which are non-display regions in the display panel 100 may be minimized.

The gate driver 120 may receive a clock received from the level shifter 140 and output gate pulses GATE. The gate pulses GATE may be supplied to the gate lines GL.

Gate pulses GATE1 to GATE3 applied to the first to third gate lines GL1 to GL3 may turn on switch elements of the subpixels 101 to select the pixels in which voltages of the data signals Vdata1 to Vdata3 are charged. The switch elements of the subpixels 101 may be turned on in response to the gate on voltage VGH of the corresponding gate pulses GATE1 to GATE3, and may be turned off in response to the gate off voltage VGL. The gate pulses GATE1 to GATE3 may swing between the gate on voltage VGH and the gate off voltage VGL. The gate driver 120 may shift the gate pulses using the shift register.

The timing controller 130 may control the operation timing of the display panel drivers 110 and 120 with a frame frequency of an input frame frequency Xi (i is a positive integer greater than 0) Hz by multiplying an input frame frequency by a factor of i. The input frame frequency is 60 Hz in the National Television Standards Committee (NTSC) method and 50 Hz in the Phase-Alternating Line (PAL) method. In one implementation, the timing controller 130 may be implemented as a field programmable gate array (FPGA), a complex programmable logic device (CPLD), or the like.

The timing controller 130 may receive the pixel data of the input image and a timing signal synchronized with the pixel data from a host system 200. The pixel data of the input image received in the timing controller 130 is a digital signal. The timing controller 130 may transmit the pixel data to the data driver 110. The timing signal may include a vertical synchronization signal Vsync, a horizontal synchronization signal Hsync, a clock signal CLK, a data enable signal DE, and the like. Since a vertical period and a horizontal period may be known by counting the data enable signal DE, the vertical synchronization signal Vsync and the horizontal synchronization signal Hsync may be omitted. The data enable signal DE may have a period of one horizontal period 1H.

The timing controller 130 may generate a data timing control signal for controlling the data driver 110, a gate timing control signal for controlling the gate driver 120, a control signal for controlling the switch elements of the demultiplexer array 112, and the like based on the timing signal received from the host system 200. The gate timing control signal may be generated as a clock of a digital signal voltage level.

The host system 200 may be any one of a television (TV), a set-top box, a navigation system, a personal computer (PC), a home theater, a mobile system, and a wearable system. In a mobile device and a wearable device, the data driver 110, the timing controller 130, the level shifter 140, and the like may be integrated into one drive IC. In the mobile system, the host system 200 may be implemented as an application processor (AP). The host system 200 may transmit the pixel data of the input image to the drive IC through a mobile industry processor interface (MIPI). The host system 200 may be connected to the drive IC through a flexible printed circuit, for example, a flexible printed circuit board (FPCB).

The clock output from the level shifter 140 may swing between the gate on voltage VGH and the gate off voltage VGL and may be supplied to the gate driver 120 through clock lines CL1 to CLn. The clock output from the level shifter 140 may be applied to at least one of the demultiplexer array 112, the gate driver 120, the data driver 110, and the touch sensor driver.

The power supply unit 300 may generate a voltage required to drive the pixel array of the display panel 100 and the display panel driving circuit using a direct current (DC)-DC converter. The DC-DC converter may include a charge pump, a regulator, a buck converter, a boost converter, a buck-boost converter, and the like. The power supply unit 300 may adjust a DC input voltage from the host system 200 to generate a DC voltage such as a gamma reference voltage VGMA, the gate on voltage VGH, the gate off voltage VGL, a half VDD HVDD, and a common voltage of the pixels. The half VDD voltage is half the voltage compared to VDD and may be used as an output buffer driving voltage of the source drive IC. The gamma reference voltage VGMA may be supplied to the data driver 110. The gamma reference voltage VGMA may be divided by gray level through a voltage divider circuit of the data driver 110 and supplied to the DAC of the data driver 110. The power supply unit 300 may generate constant voltages applied to the pixels in common, for example, a pixel driving voltage EVDD and a pixel base voltage EVSS. The power supply unit 300 may change a voltage level of an output voltage in response to a control signal VC generated from the timing controller 130.

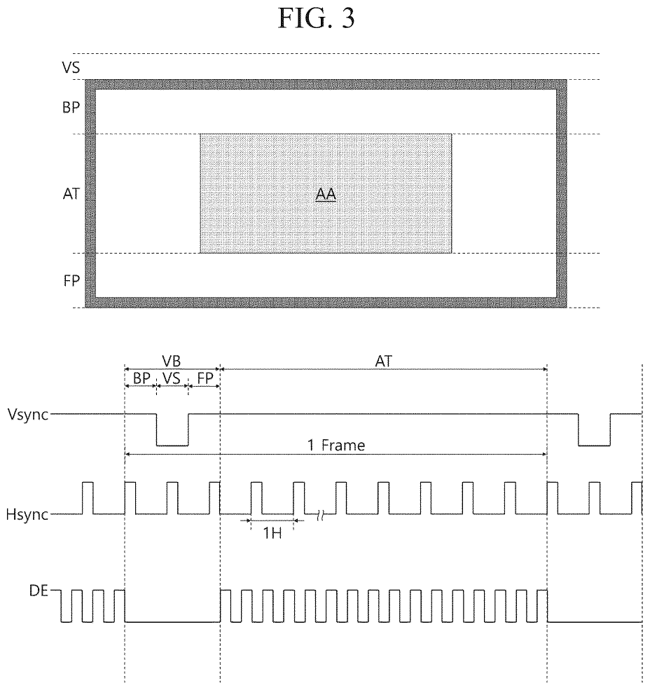

FIG. 3 is a waveform diagram showing a timing signal synchronized with an image signal.

Referring to FIG. 3, the vertical synchronization signal Vsync may define one frame period. The one frame period may be a time of the sum of an active section AT and a vertical blank section VB. The horizontal synchronization signal Hsync may define one horizontal period (a horizontal time). The data enable signal DE may be synchronized with the pixel data to be displayed on one pixel line in the input image to define a valid data section.

One pulse period of the data enable signal DE and the horizontal synchronization signal Hsync is one horizontal period 1H, and a high logic section of the data enable signal DE may represent a data input timing of one pixel line. The one horizontal period 1H may be a time required to write pixel data to pixels of one pixel line on the display panel.

The timing controller may receive the pixel data of the input image synchronized with the data enable signal DE during the active section AT and transmit the pixel data to the data driver. During the vertical blank section VB, there may be no data enable signal DE received by the timing controller and no pixel data of the input image, and there may be no pixel data transmitted to the data driver. During the active section AT, the timing controller may receive data for one frame to be written to all pixels PIX.

As can be seen from the data enable signal DE, the display device may not receive any input data during the vertical blank section VB. The vertical blank section VB may include a vertical sync time VS, a vertical front porch FP, and a vertical back porch BP. The vertical sync time VS may be a time from a falling edge to a rising edge of Vsync. The vertical sync time VS may represent a start and an end of the screen.

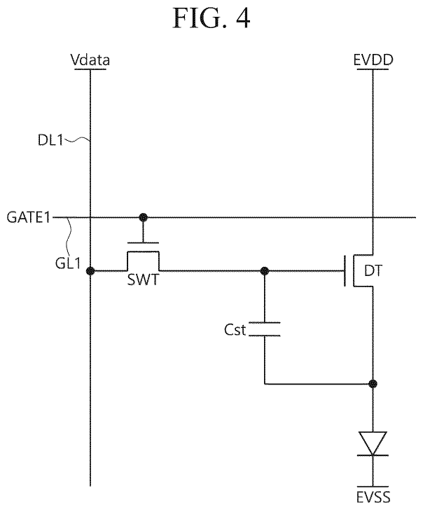

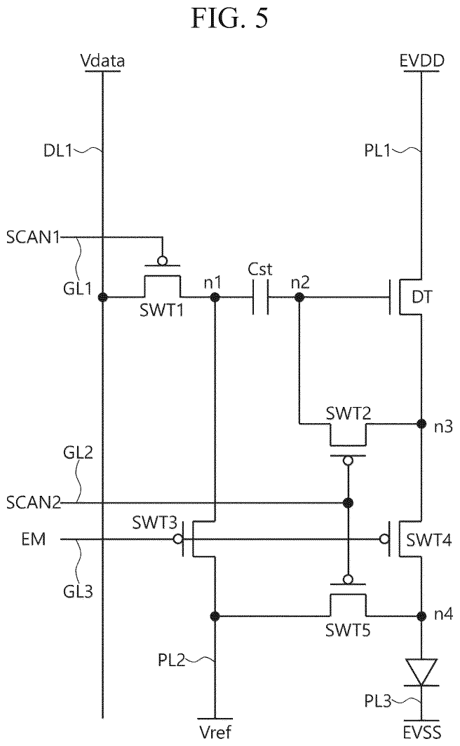

FIG. 4 is a circuit diagram showing the pixel circuit according to the implementation of the present specification. FIG. 5 is a circuit diagram showing a pixel circuit according to another implementation of the present specification.

Referring to FIG. 4, the pixel circuit may include a light-emitting element EL, a driving element DT which supplies a current to the light-emitting element EL, a switch element SWT which supplies the data signal Vdata to a gate electrode of the driving element DT in response to the gate pulse GATE, and a capacitor Cst connected between the gate electrode and a source electrode of the driving element DT. The driving element DT and the switch element SWT may be implemented as n-channel transistors.

The pixel driving voltage EVDD may be applied to a drain electrode of the driving element DT. The driving element DT may supply the current to the light-emitting element EL according to a gate-to-source voltage Vgs to drive the light-emitting element EL. The driving element DT may be turned on in response to the gate on voltage VGH of the gate pulse GATE. The light-emitting element EL may be turned on and may emit light when a forward voltage between an anode and a cathode is a threshold voltage or more. The pixel base voltage EVSS lower than the pixel driving voltage EVDD may be applied to the cathode electrode of the light-emitting element EL. The capacitor Cst may be connected between the gate electrode and the source electrode of the driving element DT to maintain the gate-to-source voltage Vgs of the driving element DT.

The light-emitting element EL may be implemented as an organic light-emitting diode (OLED) including an organic compound layer formed between the anode and the cathode. The organic compound layer may include a hole injection layer HIL, a hole transport layer HTL, an emission layer EML, an electron transport layer ETL, and an electron injection layer EIL, but the present specification is not limited thereto. When a voltage is applied to the anode and the cathode of the OLED, since holes passing through the hole transport layer HTL and electrons passing through the electron transport layer ETL move to the emission layer EML to form excitons, visible light may be emitted from the emission layer EML. The OLED used as the light-emitting element may have a tandem structure in which a plurality of light-emitting layers are stacked. The OLED of the tandem structure may enhance the brightness and lifespan of the pixels.

Referring to FIG. 5, the pixel circuit according to another implementation may include a light-emitting element EL, a plurality of thin film transistors SWT1 to SWT5 and DT, a capacitor Cst, and the like. The transistors SWT1 to SWT5 and DT may be implemented as p-channel transistors (PMOS), but the present specification is not limited thereto.

The switch transistors SWT1 to SWT5 may be turned on/off according to gate signals from gate lines GL1 to GL3 to initialize the pixel circuit, connect a source and a drain of the driving transistor DT, and then supply a data voltage to the capacitor Cst. Further, the switch transistors SWT1 to SWT5 may switch a current path between the driving transistor DT and the light-emitting element EL. When a gate and the drain of the driving transistor DT are connected, since the driving transistor DT operates in a diode form, a source-to-gate voltage of the driving transistor DT rises to a threshold voltage of the driving transistor DT and may be sampled by the capacitor Cst.

The light-emitting element EL may be implemented as an OLED. The OLED may include an organic compound layer formed between an anode and a cathode. The organic compound layer may include a hole injection layer HIL, a hole transport layer HTL, an emission layer EML, an electron transport layer ETL, an electron injection layer EIL, and the like, but the present specification is not limited thereto. The anode of the OLED may be connected to fourth and fifth switch transistors SWT4 and SWT5 through a fourth node n4. The cathode of the OLED may be connected to a third power line PL3 to which EVSS is applied. The driving transistor DT may supply a current to the OLED to drive the OLED. The OLED may emit light with a current amount controlled by the driving transistor DT according to a data voltage Vdata. A current path of the OLED may be switched by the fourth switch transistor SWT4.

The capacitor Cst may be connected between a first node n1 and a second node n2. The first node n1 may be connected to a second electrode of a first switch transistor SWT1, a first electrode of a third switch transistor SWT3, and a first electrode of the capacitor Cst. The second node n2 may be connected to a second electrode of the capacitor Cst, the gate of a driving element DT, and a first electrode of a second switch transistor SWT2. The data voltage Vdata compensated for by the threshold voltage Vth of the driving transistor DT sampled may be charged in the capacitor Cst. Accordingly, since the data voltage Vdata in each of the subpixels is compensated for by the threshold voltage Vth of the driving transistor DT, the characteristic deviation of the driving transistor in the subpixels may be compensated to be driven with uniform driving characteristics.

The first switch transistor SWT1 is a switch element which supplies the data voltage Vdata to the first node n1 in response to a gate on voltage of a first scan signal SCAN1. The first switch transistor SWT1 may include a gate connected to a first gate line GL1, a first electrode connected to a data line DL, and a second electrode connected to the first node n1. The first scan signal SCAN1 may be simultaneously applied to pixels disposed in two lines of the pixel array through the first gate line GL1. The first scan signal SCAN1 may define a compensation period for sampling the threshold voltage of the driving transistor DT in the pixels disposed in two lines and charging the data voltage to the pixels. The first scan signal SCAN1 may be generated as a pulse of the gate on voltage.

The second switch transistor SWT2 may connect a gate and a second electrode of the driving transistor DT in response to a gate on voltage of a second scan signal SCAN2. The second switch transistor SWT2 may include a gate connected to a second gate line GL2, a first electrode connected to the second node n2, and a second electrode connected to a third node n3.

The third switch transistor SWT3 may initialize the first node n1 to Vref by supplying the Vref to the first node n1 in response to a gate on voltage of an EM signal EM. The third switch transistor SWT3 may include a gate connected to a third gate line GL3, a first electrode connected to the first node n1, and a second electrode connected to a second power line PL2. The EM signal EM may define an emission time of the light-emitting element EL.

The fourth switch transistor SWT4 may switch a current path of the light-emitting element EL in response to the EM signal EM. A gate of the fourth switch transistor SWT4 may be connected to the third gate line GL3. A first electrode of the fourth switch transistor SWT4 may be connected to the third node n3, and a second electrode of the fourth switch transistor SWT4 may be connected to the fourth node n4.

The fifth switch transistor SWT5 may initialize a voltage of the fourth node n4 connected to the anode of the light-emitting element EL to the Vref in response to the second scan signal SCAN2. The fifth switch transistor SWT5 may include a gate connected to the second gate line GL2, a first electrode connected to the second power line PL2, and a second electrode connected to the fourth node n4.

The driving transistor DT is a driving element that controls a current flowing through the light-emitting element EL according to a gate-to-source voltage Vgs. The driving transistor DT may include the gate connected to the second node n2, a first electrode connected to a first power line PL1, and the second electrode connected to the third node n3. The ELVDD may be supplied to the pixels through the first power line PL1.

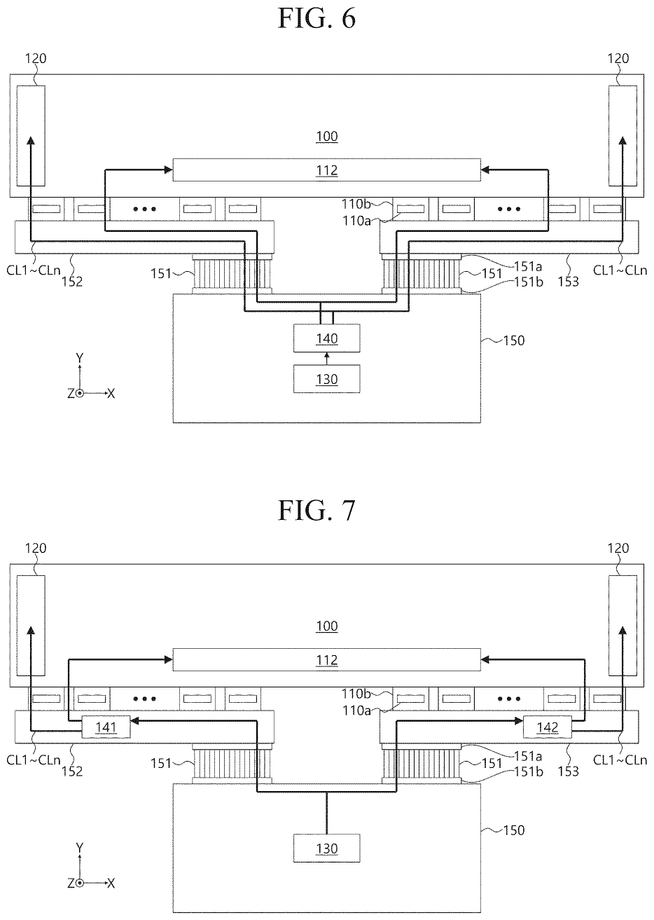

FIGS. 6 to 8 are views showing various implementations of the level shifter in the display device according to the implementation of the present specification.

Referring to FIGS. 6 to 8, a control board 150 may be connected to first and second source PCBs 152 and 153 through a flexible circuit board, for example, a flexible circuit board 151 such as a flexible flat cable (FFC) or FPCB, and connectors 151a and 151b. The source drive ICs 110a may be connected between the source PCBs 152 and 153 and the display panel 100.

Referring to FIG. 6, the timing controller 130 and the level shifter 140 may be mounted on the control board 150. Input terminals of the level shifter 140 may be connected to the timing controller 130 through lines formed on the control board 150. Output terminals of the level shifter 140 may be connected to the gate driver 120 through lines which connect the flexible circuit board 151, the source PCB 152, a COF 110b, and the gate driver 120 on the display panel 100.

Referring to FIG. 7, level shifters 141 and 142 may be mounted on the source PCBs 152 and 153, respectively. The level shifters 141 and 142 may include a first level shifter 141 mounted on the first source PCB 152, and a second level shifter 142 mounted on the second source PCB 153. Input terminals of the level shifters 141 and 142 may be connected to the timing controller 130 through lines which connect the control board 150, the flexible circuit board 151, and the source PCBs 152 and 153. Output terminals of the level shifters 141 and 142 may be connected to the gate driver 120 through lines which connect the source PCBs 152 and 153, the COF 110b, and the gate driver 120 on the display panel 100.

Referring to FIG. 8, level shifters 141 and 142 may be connected to the source drive IC 110a. The timing controller 130 may transmit a video data packet including the pixel data of the input image and a control packet including various types of control information to the source drive IC 110a. The timing controller 130 may encode gate timing control information into the control packet and transmit the gate timing control information to the source drive IC 110a, and the source drive IC 110a may generate a gate timing control signal from the gate timing control information and provide the gate timing control signal to the level shifter 141 and 142.

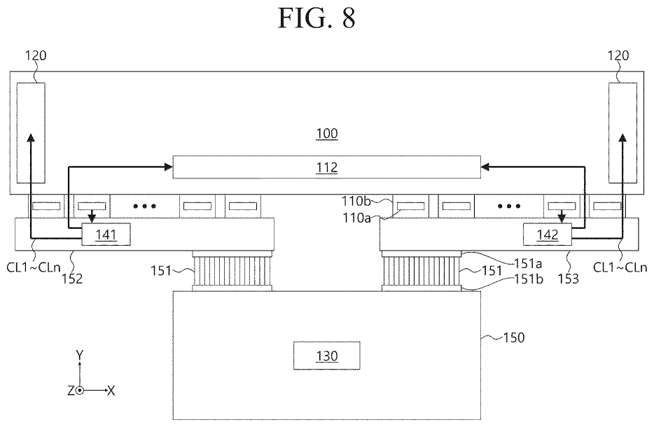

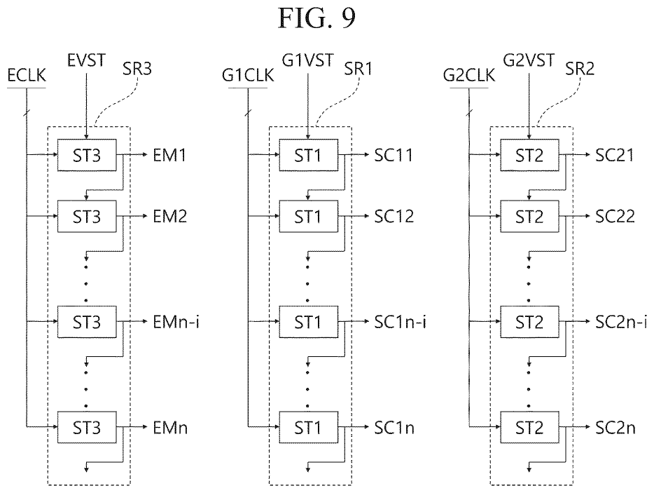

FIG. 9 is a view schematically showing a gate driver which outputs gate signals. FIG. 10 is a view showing a gate driver which outputs gate signals applied to the pixel circuit.

Referring to FIG. 9, the gate driver may include a first shift register SR1 that sequentially outputs pulses of first scan signals SC1n-i and SC1n, a second shift register SR2 that sequentially outputs pulses of second scan signals SC2n-i and SC2n, and a third shift register SR3 that outputs pulses of EM signals EMn-i and EMn.

The first shift register SR1 may include a plurality of stages ST1 which are cascaded. The first shift register SR1 may receive a start pulse G1VST and a clock G1CLK and sequentially output pulses of the first scan signals in order of SC11, SC12, . . . , SC1n-i, and SC1n.

The second shift register SR2 may include a plurality of stages ST2 which are cascaded. The second shift register SR2 may receive a start pulse G2VST and a clock G2CLK and sequentially output pulses of the second scan signals in order of SC21, SC22, . . . , SC2n-I, and SC2n.

The third shift register SR3 may include a plurality of stages ST3 which are cascaded. The third shift register SR3 may receive a start pulse EVST and a clock ECLK and sequentially output pulses of the EM signals in order of EM1, EM2, . . . , EMn-I, and EMn.

The clock signals CLK input to the shift registers SR1, SR2, and SR3 may be two or more clocks having different phases. The start pulses and clocks input to the shift registers SR1, SR2, and SR3 may different from each other in one or more of their phases, frequencies, and duty ratios.

Referring to FIG. 10, the gate driver may include a first shift register SR1 which sequentially outputs pulses of a first scan signal SC1n, a second shift register SR2 which sequentially outputs pulses of a second scan signal SC2n, and a third shift register SR3 which outputs pulses of an EM signal EMn.

The first shift register SR1 may include a plurality of stages ST1 which are cascaded. The first shift register SR1 may receive a start pulse G1VST and clocks G1CLK1, G1CLK2, G1CLK3, and G1CLK4 and sequentially output pulses of the first scan signal SC1n. The clocks G1CLK1, G1CLK2, G1CLK3, and G1CLK4 may include two or more shift clocks having different phases.

The second shift register SR2 may include a plurality of stages ST2 which are cascaded. The second shift register SR2 may receive a start pulse G2VST and clocks G2CLK1, G2CLK2, G2CLK3, G2CLK4, and G2CLK5 and sequentially output pulses of the second scan signal SC2n. The clocks G2CLK1, G2CLK2, G2CLK3, G2CLK4, and G2CLK5 may include two or more shift clocks with different phases.

The third shift register SR3 may include a plurality of stages ST3 which are cascaded. The third shift register SR3 may receive a start pulse EVST and clocks ECLK1 and ECLK2 and sequentially output pulses of the EM signal EMn. The clocks ECLK1 and ECLK2 may include two or more shift clocks having different phases. A pulse width of the EM signal EMn may be set to be wider than one horizontal period to be simultaneously applied to pixels located on a plurality of pixel lines.

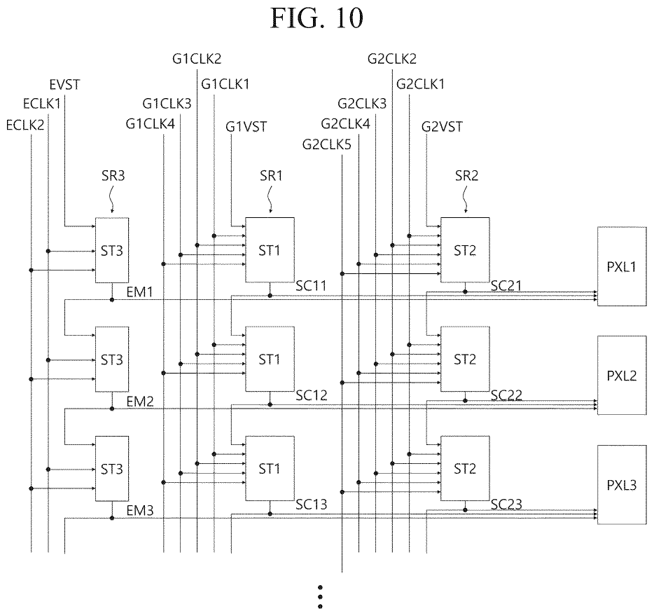

FIG. 11 is a circuit diagram schematically showing a shift register of a gate driver.

Referring to FIG. 11, a shift register of a gate driver GIP may include stages STs which are cascaded. The shift register may receive a start pulse VST or a carry signal CAR and may receive clocks CLK1 to CLKn. The carry signal CAR may be output from a previous stage.

A driver of each of the stages ST may charge and discharge a first control node Q and a second control node QB. An output buffer of each of the stages ST may include a pull-up transistor Tu and a pull-down transistor Td.

The pull-up transistor Tu may be turned on when the clocks CLK1 to CLKn are input while the first control node Q is charged, and output an output node as a gate on voltage. The pull-down transistor Td may be turned on when the second control node QB is charged, and output an output node as a gate off voltage.

An output buffer of the gate driver GIP may be connected to the gate line. The pulses of the gate signals SCAN and EM output through the output buffers of each channel of the gate driver GIP may swing between the gate on voltage and the gate off voltage, and phases may be sequentially shifted.

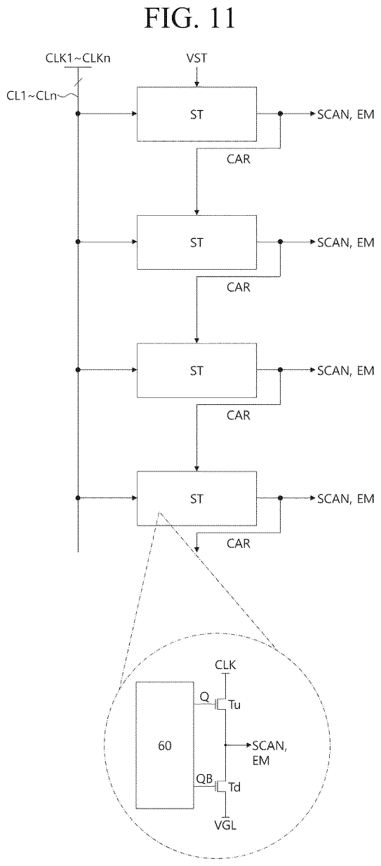

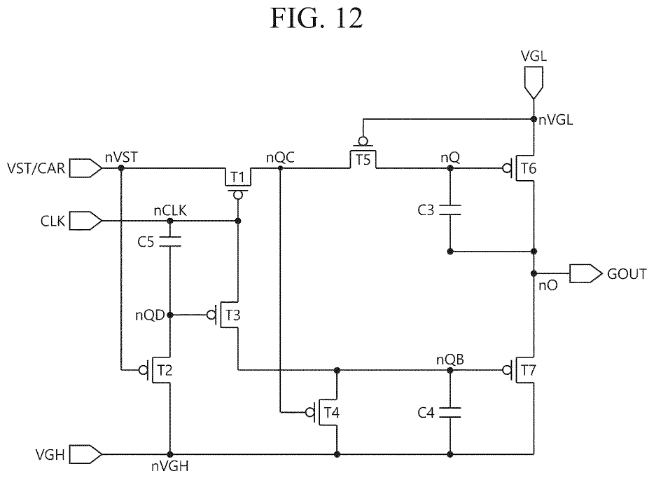

FIG. 12 is a circuit diagram showing a circuit of the stage according to the implementation of the present specification. FIG. 13 is a waveform diagram showing an input/output waveform of the circuit of the stage according to the implementation of the present specification.

Referring to FIGS. 12 and 13, an n-th stage circuit may include a plurality of transistors T1 to T7, a plurality of capacitors C3 to C5, and nodes which interconnect the transistors and the capacitors.

Each of the first to seventh transistors T1 to T7 may include a p-channel TFT. The p-channel TFT may be turned on in response to a gate low voltage VGL shown in FIG. 13, but may be turned off in response to a gate high voltage VGH. In the case of the p-channel TFT, the gate on voltage may be the gate low voltage VGL, and the gate off voltage may be the gate high voltage VGH.

The stage circuit may include a CLK node nCLK to which a clock signal CLK is input, a VST node nVST to which a start signal or a carry signal VST/CAR from a previous stage is input, a first control node nQ, a second control node nQB, an output node nO which outputs a gate signal GOUT and/or a carry signal, a gate on voltage node (hereinafter, may be abbreviated as a “VGL node”) nVGL to which the gate on voltage VGL is applied, a gate off voltage node (hereinafter, may be abbreviated as a “VGH node”) nVGH to which the gate off voltage VGH is applied, and the like.

The gate on voltage VGL applied to the VGL node may be a first constant voltage. The gate on voltage VGL applied to the VGL node may be a voltage which swings between the gate high voltage and the gate low voltage. The gate off voltage VGH applied to the VGH node may be a second constant voltage.

Hereinafter, the fact that a specific node is “activated” means that the gate on voltage or a voltage corresponding to the gate on voltage may be applied to the node. The fact that a specific node is “deactivated” means that the gate off voltage or a voltage corresponding to the gate off voltage may be applied to the node.

The stage circuit may include a Q controller, a QB controller, an output unit, and a first stabilization unit.

The Q controller may include the first transistor T1. The first transistor T1 may activate a QC node nQC by applying the start signal VST/CAR of the gate on voltage to the QC node nQC in response to the clock signal CLK. A gate electrode of the first transistor T1 may be connected to the CLK node nCLK, and a first electrode and a second electrode of the first transistor T1 may be connected to the VST node nVST and the QC node nQC, respectively.

The QB controller may activate the second control node nQB to be opposite to the QC node nQC in response to the clock signal CLK, the start signal VST/CAR, and a potential of the QC node nQC. The QB controller may include a fifth capacitor C5, the second transistor T2, the third transistor T3, the fourth transistor T4, and a fourth capacitor C4.

The fifth capacitor C5 may be connected between the CLK node nCLK and the QD node nQD. The third transistor T3 may supply the clock signal CLK to the second control node nQB in response to the potential of the QD node nQD. A gate electrode of the third transistor T3 may be connected to the QD node nQD, and a first electrode and a second electrode of the third transistor T3 may be connected to the CLK node nCLK and the second control node nQB, respectively.

The second transistor T2 may supply the gate off voltage to the QD node nQD in response to the start signal VST/CAR. A gate electrode of the second transistor T2 may be connected to the VST node nVST, and a first electrode and a second electrode of the second transistor T2 may be connected to the QD node nQD and the VGH node nVGH, respectively. The potential of the QD node nQD may be synchronized to the clock signal CLK while the start signal VST/CAR is maintained at the gate off voltage. The potential of the QD node nQD may be the gate off voltage while the start signal VST/CAR is maintained at the gate on voltage.

The fourth transistor T4 may supply the gate off voltage to the second control node nQB in response to the potential of the QC node nQC. A gate electrode of the fourth transistor T4 may be connected to the QC node nQC, and a first electrode and a second electrode of the fourth transistor T4 may be connected to the second control node nQB and the VGH node nVGH, respectively.

The fourth capacitor C4 may be connected between the second control node nQB and the VGH node nVGH to stabilize the potential of the second control node nQB.

The output unit may include the sixth transistor T6 which is a pull-down element, the seventh transistor T7 which is a pull-up element, and a third capacitor C3.

The sixth transistor T6 may supply the gate signal GOUT of the gate on voltage VGL to the output node nO from the time when the first control node nQ is bootstrapped in synchronization with a timing when the QC node nQC is activated. A gate electrode of the sixth transistor T6 may be connected to the first control node nQ, and a first electrode and a second electrode of the sixth transistor T6 may be connected to the VGL node nVGL and the output node nO, respectively.

The third capacitor C3 may be connected between the first control node nQ and the output node nO. The third capacitor C3 may serve to bootstrap the first control node nQ by reflecting a change in a potential of the output node nO to a potential of the first control node nQ when the gate signal GOUT changes from the gate off voltage to the gate on voltage.

The seventh transistor T7 may supply the gate signal GOUT of the gate off voltage VGH to the output node nO while the second control node nQB is activated. A gate electrode of the seventh transistor T7 may be connected to the second control node nQB, and a first electrode and a second electrode of the seventh transistor T7 may be connected to the output node nO and the VGH node nVGH, respectively.

The first stabilization unit may include the fifth transistor T5. A gate electrode of the fifth transistor T5 may be connected to the VGL node nVGL, and a first electrode and a second electrode of the fifth transistor T5 may be connected to the QC node nQC and the first control node nQ, respectively. A channel current between the first electrode and the second electrode of the fifth transistor T5 may be zero when the first control node nQ is bootstrapped. The fifth transistor T5 may be turned off when the first control node nQ is bootstrapped, and thus may block an electrical connection between the QC node nQC and the first control node nQ. The fifth transistor T5 may be maintained in a turn-on state while the first control node nQ is not bootstrapped.

The fifth transistor T5 may be maintained in the turn-on state and may be turned off only when the first control node nQ is bootstrapped, and thus may block a current flow between the QC node nQC and the first control node nQ. When the first control node nQ is bootstrapped, the potential of the QC node nQC may be different from the potential of the first control node nQ. Since the potential of the QC node nQC does not change even when the potential of the first control node nQ changes when bootstrapping, the first and fourth transistors T1 and T4 connected to the QC node nQC may be prevented from being overloaded when bootstrapping.

When there is no fifth transistor T5, a drain-to-source voltage Vds of the first transistor T1 and a gate-to-source voltage Vgs of the fourth transistor T4 may increase to a threshold value or more due to bootstrapping, and when the overloading phenomenon continues, an element destruction phenomenon, so-called breakdown phenomenon, may occur. The fifth transistor T5 may prevent the first and fourth transistors T1 and T4 connected to the QC node nQC from breaking down when bootstrapping of the first control node nQ.

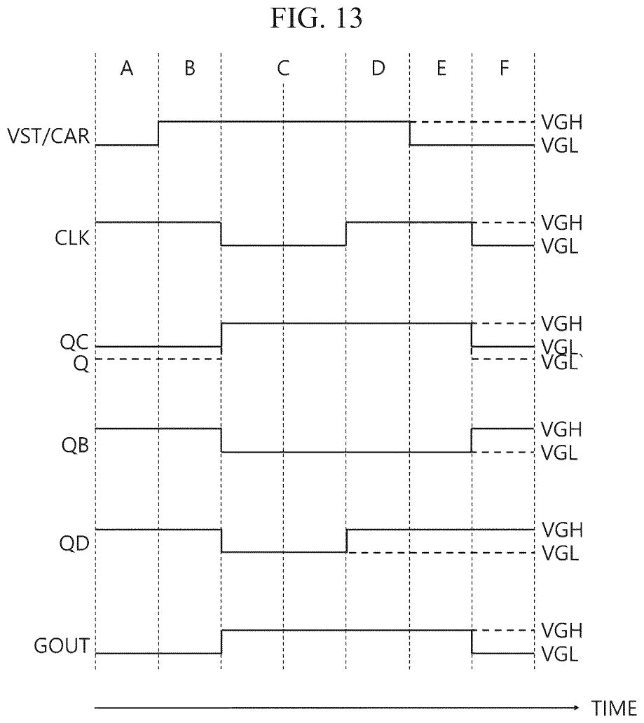

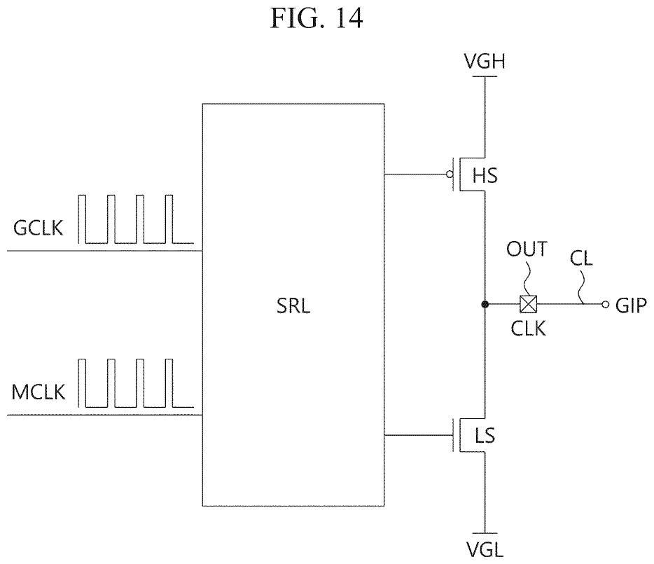

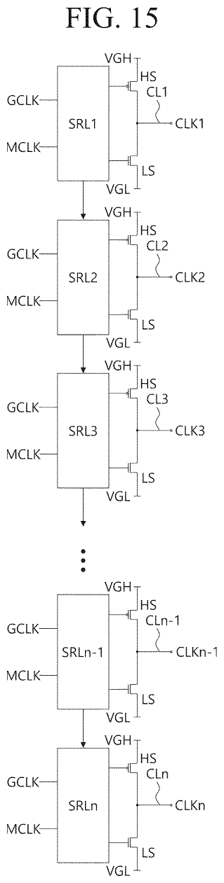

FIG. 14 is a circuit diagram showing one channel of the level shifter. FIG. 15 is a circuit diagram showing a channel of the level shifter. FIG. 16 is a waveform diagram showing an input/output signal of the level shifter.

Referring to FIGS. 14 and 15, one channel of the level shifter 140 may include a driver SRL which receives first and second input clocks GCLK and MCLK, a pull-up transistor HS driven by the driver SRL, and a pull-down transistor LS driven by the driver SRL. ‘GIP’ represents the gate driver 120. Channels of the level shifters 140 to 142 may be connected to the clock lines CL through the output terminals, respectively.

The first and second input clocks GCLK and MCLK may be generated from the timing controller 130 and input to the driver SRL. The driver SRL may turn on the pull-up transistor HS in response to the first input clock GCLK and turn on the pull-down transistor LS in response to the second input clock MCLK. The driver SRL may turn on the pull-up transistor HS at a rising edge of the first input clock GCLK and turn on the pull-down transistor LS at a falling edge of the second input clock MCLK, but the present specification is not limited thereto. When the pull-up transistor HS is turned on and the pull-down transistor LS is turned off, a voltage at an output terminal OUT may be charged to the gate on voltage VGH. When the pull-up transistor HS is turned off and the pull-down transistor LS is turned on, the voltage at the output terminal OUT may be discharged to the gate off voltage VGL.

Referring to FIGS. 15 and 16, the level shifter 140 may output clocks CLK1 to CLKn whose phases are sequentially shifted through a plurality of channels. Drivers SRL1 to SRLn may transmit the carry signal to a driver of a next channel. The first to n-th drivers SRL1 to SRLn may be enabled and may generate an output when the carry signal is input.

At least portions of the clocks CLK1 to CLKn output from the level shifter 140 may overlap. In this case, the gate driver GIP which receives the clocks CLK1 to CLKn may sequentially supply pulses of at least partially overlapping gate signals to the gate lines GL.

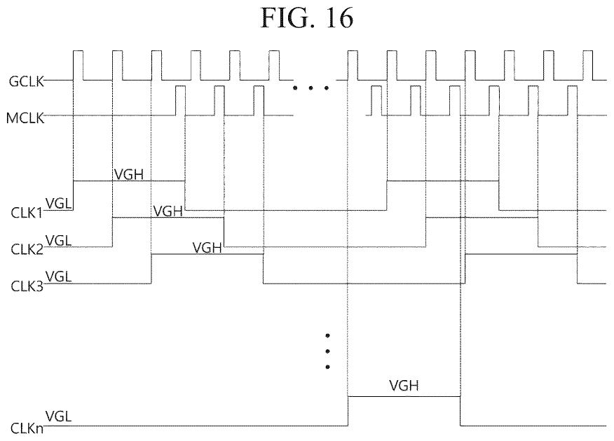

FIG. 17 is a block diagram showing the display device including the level shifter.

Referring to FIG. 17, the display region of the display device may be divided and driven into display regions where a plurality of images are displayed. For example, the display region may include a first display region DA1 where a first image is displayed, a second display region DA2 where a second image is displayed, and the like. Alternatively, the display region may be divided and driven into a first display region DA1 where a first image is displayed, a second display region DA2 where a second image is displayed, and a third display region DA3 where a third image is displayed.

In one example, the first display region DA1 may be a high-speed driving region, the second display region DA2 may be a low-speed driving region, and the third display region DA3 may be an intermediate-speed driving region. For example, the first display region DA1 may be a high-speed driving region where an image is updated at a frame frequency of 120 Hz. The second display region DA2 may be a low-speed driving region where the image is updated at a frame frequency of 30 Hz. The third display region DA3 may be an intermediate-speed driving region where the image is updated at a frame frequency of 60 Hz. However, the implementations of the present specification are not limited thereto.

As described above, a plurality of gate drivers 120 may be disposed in the display region of the display device. The gate driver 120 may include a shift register and the like. The level shifter 140 may receive a gate timing control signal for controlling the gate driver 120 from the timing controller 130 and transmit a clock signal to the gate driver 120 through the source drive ICs 110a on the COF 110b.

The display regions DA1, DA2, and DA3 are driven without reflecting the amount of change in data in each divided region when the display regions DA1, DA2, and DA3 are divided and driven with the same frame frequency in all regions. A standard for a region with a relatively large amount of data change (for example, the first display region DA1) needs to be applied the same for all regions, and in this case, all regions DA1, DA2, and DA3 may be driven at a relatively high speed, which result in increased power consumption.

The present specification may provide a display device which adjusts the frame frequency according to each divided driving region by additionally arranging the level shifter 140 based on the number of regions which are divided and driven. Accordingly, the power consumption of the display device divided and driven in a horizontal direction may be reduced.

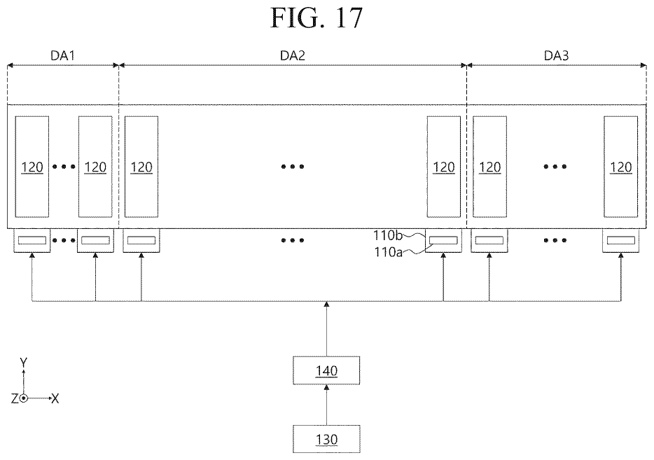

FIG. 18 is a block diagram showing a display device according to a first implementation of the present specification.

Referring to FIG. 18, the display device may include a display panel 100, a plurality of level shifters 140, and a timing controller 130. The display panel 100 may include a plurality of gate drivers 120 and a plurality of pixels disposed in a matrix form (see FIG. 2). In one implementation, at least some of the plurality of gate drivers 120 may be disposed in the display panel 100. The plurality of gate drivers 120 may be disposed between the plurality of pixels. The display device may further include a plurality of source drive ICs 110a disposed between the plurality of level shifters 140 and the plurality of gate drivers 120.

The level shifter 140 may be connected to the timing controller 130 to receive the above-described input clock. The level shifter 140 may generate a clock signal from the input clock and transmit the clock signal to the source drive IC 110a, and the source drive IC 110a may transmit the clock signal to the gate driver 120.

The source drive IC 110a according to the implementation may be mounted on a COF 110b and connected to the level shifter 140 and the gate driver 120.

The display panel may include a plurality of display regions. The plurality of display regions may include a first display region DA1, a second display region DA2, and a third display region DA3, but the implementations of the present specification are not limited thereto. The first display region DA1 may be driven at a first frame frequency. The second display region DA2 may be driven at a second frame frequency. The third display region DA3 may be driven at a third frame frequency. In one implementation, the first frame frequency may be greater than the second frame frequency and the third frame frequency, and the third frame frequency may be greater than the second frame frequency. For example, the first frame frequency may be 120 Hz, the second frame frequency may be 15 Hz to 30 Hz, and the third frame frequency may be 60 Hz, but the implementations of the present specification are not limited thereto.

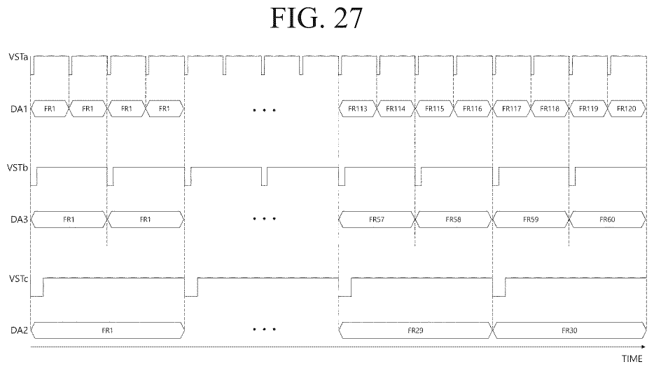

The frame frequencies at which the plurality of display regions are driven may all be different from each other. For example, the first frame frequency, the second frame frequency, and the third frame frequency may all be different from each other (see FIG. 27).

The display region may be divided in the horizontal direction. For example, the second display region DA2 may be disposed in the first direction (for example, in the X-axis direction) from the first display region DA1, and the third display region DA3 may be disposed in the first direction from the second display region DA2.

The plurality of gate drivers 120 may be disposed to extend in the second direction (for example, in the Y-axis direction). The plurality of gate drivers 120 may be disposed in the horizontal direction. For example, the plurality of gate drivers 120 may include a first gate driver 121, a second gate driver 122, and a third gate driver 123, and the second gate driver 122 may be disposed in the first direction from the first gate driver 121, and the third gate driver 123 may be disposed in the first direction from the second gate driver 122.

The plurality of gate drivers 120 may include the first gate driver 121 disposed in the first display region DA1, the second gate driver 122 disposed in the second display region DA2, and the third gate driver 123 disposed in the third display region DA3.

A plurality of first gate drivers 121, a plurality of second gate drivers 122, and a plurality of third gate drivers 123 may be formed. For example, the first gate driver 121 may include a 1-1 gate driver 1211, a 1-2 gate driver 1212, . . . , and a 1-n gate driver 121n. The second gate driver 122 may include a 2-1 gate driver 1221, a 2-2 gate driver 1222, . . . , and a 2-n gate driver 122n. The third gate driver 123 may include a 3-1 gate driver 1231, a 3-2 gate driver 1232, . . . , and a 3-n gate driver 123n.

The plurality of level shifters 140 may include a first level shifter 141 connected to the first gate driver 121, a second level shifter 142 connected to the second gate driver 122, and a third level shifter 143 connected to the third gate driver 123.

A plurality of first level shifters 141, a plurality of second level shifters 142, and a plurality of third level shifters 143 may be formed. For example, the first level shifter 141 may include a 1-1 level shifter 1411, a 1-2 level shifter 1412, . . . , and a 1-n level shifter 141n. The second level shifter 142 may include a 2-1 level shifter 1421, a 2-2 level shifter 1422, . . . , and a 2-n level shifter 142n. The third level shifter 143 may include a 3-1 level shifter 1431, a 3-2 level shifter 1432, . . . , and a 3-n level shifter 143n.

The plurality of source drive ICs 110a may include a first source drive IC 111a connected to the first level shifter 141 and the first gate driver 121, a second source drive IC 112a connected to the second level shifter 142 and the second gate driver 122, and a third source drive IC 113a connected to the third level shifter 143 and the third gate driver 123.

A plurality of first source drive ICs 111a, a plurality of second source drive ICs 112a, and a plurality of third source drive ICs 113a may be formed. For example, the first source drive IC 111a may include a 1-1 source drive IC 111a1, a 1-2 source drive IC 111a2, . . . , and a 1-n source drive IC 111an. The second source drive IC 112a may include a 2-1 source drive IC 112a1, a 2-2 source drive IC 112a2, . . . , and a 2-n source drive IC 112an. The third source drive IC 113a may include a 3-1 source drive IC 113a1, a 3-2 source drive IC 113a2, . . . , and a 3-n source drive IC 113an.

In one implementation, the 1-1 gate driver 1211 to the 1-n gate driver 121n may be connected to the 1-1 gate driver 1211 and the 1-n gate driver 121n, respectively. The 1-1 source drive IC 111a1 to the 1-n source drive IC 111an may be connected to the 1-1 level shifter 1411 to the 1-n level shifter 141n, respectively. The 1-1 source drive IC 111a1 to the 1-n source drive IC 111an may be connected to the 1-1 gate driver 1211 to the 1-n gate driver 121n, respectively.

The present specification may provide a display device which adjusts the frame frequency according to each of the divided driving regions DA1, DA2, and DA3 by forming the plurality of level shifters 140 based on the number of regions which are divided and driven. For example, the first level shifter 141 may provide a frequency driven at a high speed, the second level shifter 142 may provide a frequency driven at a low speed, and the third level shifter 143 may provide a frequency driven at an intermediate speed. Accordingly, the regions divided in the horizontal direction may be respectively driven only at the corresponding frequencies, and accordingly, reduce power consumption of a display device and enable low power operation of the display device.

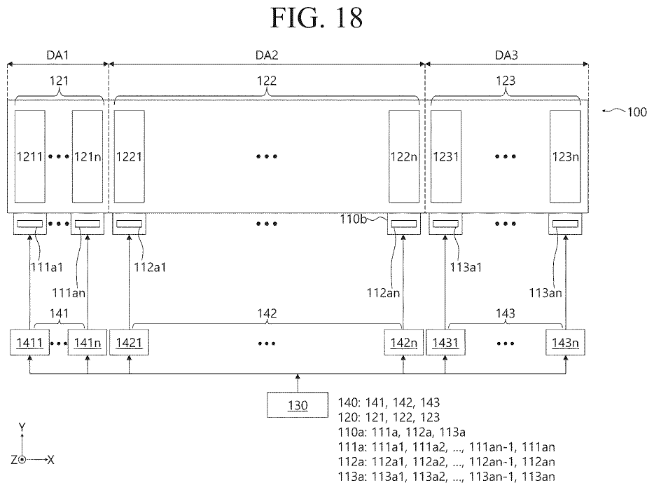

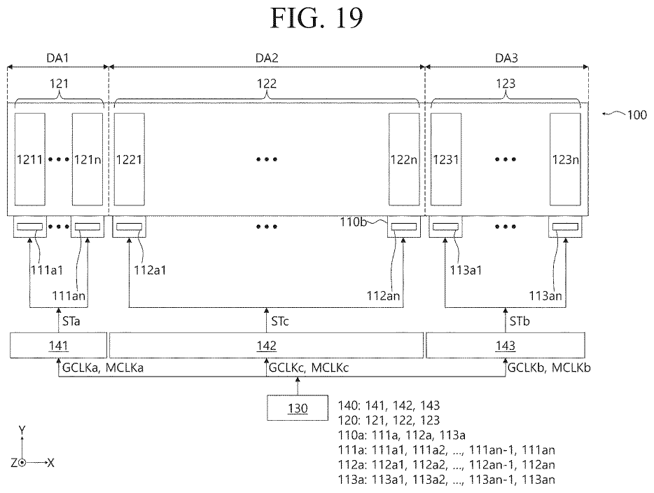

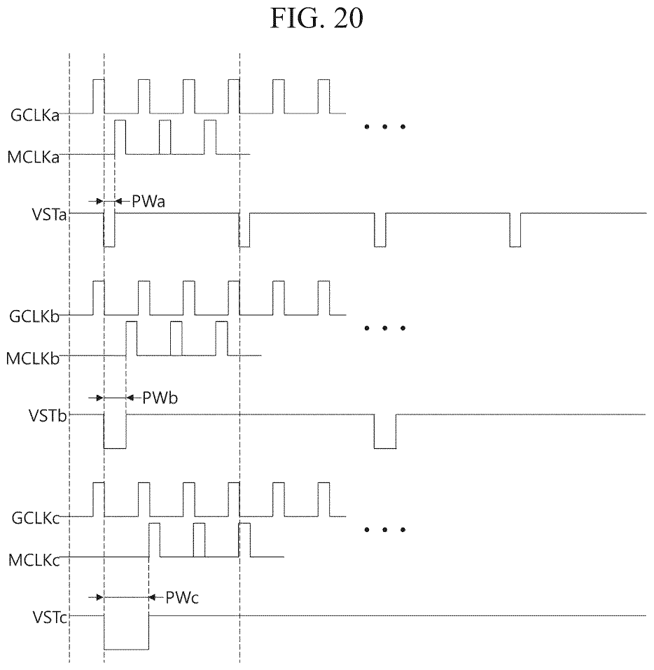

FIG. 19 is a block diagram showing a display device according to a second implementation of the present specification. FIG. 20 is a waveform diagram showing exemplary input/output signals of a level shifter included in the display device according to the second implementation. FIG. 21 is a waveform diagram showing exemplary output signals of the level shifter included in the display device according to the second implementation.

Referring to FIG. 19, a timing controller 130 may provide different input clocks to each of first to third level shifters 141, 142, and 143. The timing controller 130 may transmit a plurality of input clocks for providing different driving frame frequencies to a plurality of level shifters 141, 142, and 143, respectively.

For example, the plurality of input clocks may include a 1a input clock GCLKa, a 2a input clock MCLKa, a 1b input clock GCLKb, a 2b input clock MCLKb, a 1c input clock GCLKc, and a 2c input clock MCLKc. The 1a input clock GCLKa and the 2a input clock MCLKa may be transmitted to the first level shifter 141. The 1b input clock GCLKb and the 2b input clock MCLKb may be transmitted to the third level shifter 143. The 1c input clock GCLKc and the 2c input clock MCLKc may be transmitted to the second level shifter 142.

Referring to FIGS. 19 and 20, the first level shifter 141 may generate a start signal VSTa input to a first gate driver 121 from the 1a input clock GCLKa and the 2a input clock MCLKa. A driver of the first level shifter 141 may generate the start signal by turning on a pull-up transistor or a pull-down transistor in response to the 1a input clock GCLKa and the 2a input clock MCLKa. For example, the driver may turn on the pull-up transistor in response to a falling edge of the 1a input clock GCLKa and turn on the pull-down transistor in response to a rising edge of the 2a input clock MCLKa, but the present specification is not limited thereto. When the pull-up transistor or the pull-down transistor is turned on or turned off, as a voltage of an output terminal is charged to a gate on voltage or discharged to a gate off voltage, the start signal VSTa may be output.

The second level shifter 142 may generate a start signal VSTc input to a second gate driver 122 from the 1c input clock GCLKc and the 2c input clock MCLKc. A driver of the second level shifter 142 may generate the start signal by turning on a pull-up transistor or a pull-down transistor in response to the 1c input clock GCLKc and the 2c input clock MCLKc. For example, the driver may turn on the pull-up transistor in response to a falling edge of the 1c input clock GCLKc and turn on the pull-down transistor in response to a rising edge of the 2c input clock MCLKc, but the present specification is not limited thereto. When the pull-up transistor or the pull-down transistor is turned on or turned off, as a voltage of an output terminal is charged to the gate on voltage or discharged to the gate off voltage, the start signal VSTc may be output.

The third level shifter 143 may generate a start signal VSTb input to a third gate driver 123 from the 1b input clock GCLKb and the 2b input clock MCLKb. A driver of the third level shifter 143 may generate the start signal by turning on a pull-up transistor or a pull-down transistor in response to the 1b input clock GCLKb and the 2b input clock MCLKb. For example, the driver may turn on the pull-up transistor in response to a falling edge of the 1b input clock GCLKb and turn on the pull-down transistor in response to a rising edge of the 2b input clock MCLKb, but the present specification is not limited thereto. When the pull-up transistor or the pull-down transistor is turned on or turned off, as a voltage of an output terminal is charged to the gate on voltage or discharged to the gate off voltage, the start signal VSTb may be output.

In one implementation, pulse widths PWa, PWb, and PWc of the start signals VSTa, VSTb, and VSTc input to each of the gate drivers 121, 122, and 123 may be different from each other. The pulse width PWa of the start signal VSTa input to the first gate driver 121 may be half the pulse width PWb of the start signal VSTb input to the third gate driver 123. The pulse width PWb of the start signal VSTb input to the third gate driver 123 may be half the pulse width PWc of the start signal VSTc input to the second gate driver 122. A sampling period may be secured and a driving frequency may be freely adjusted by adjusting the pulse widths PWa, PWb, and PWc of the start signals.

Referring to FIGS. 19 to 21, an a-th output signal STa may include the start signal VSTa and clock signals CLK1a, CLK2a, CLK3a, and CLK4a input to the first gate driver 121. A b-th output signal STb may include the start signal VSTb and clock signals CLK1b, CLK2b, CLK3b, and CLK4b input to the third gate driver 123. A c-th output signal STc may include the start signal VSTc and clock signals CLK1c, CLK2c, CLK3c, and CLK4c input to the second gate driver 122.

The display device according to the implementation of the present specification may adjust a driving frame frequency of each display region DA1, DA2, and DA3 by arranging the plurality of level shifters 141, 142, and 143. In one implementation, a period Pa of the a-th output signal STa may be half a period Pb of the b-th output signal STb. The period Pb of the b-th output signal STb may be half a period Pc of the c-th output signal STc. A pulse width of the a-th output signal STa may be half a pulse width of the b-th output signal STb. The pulse width of the b-th output signal STb may be half a pulse width of the c-th output signal STc. However, the implementations of the present specification are not limited thereto. A sampling period may be secured and a driving frequency may be freely adjusted by adjusting the pulse widths of the output signals.

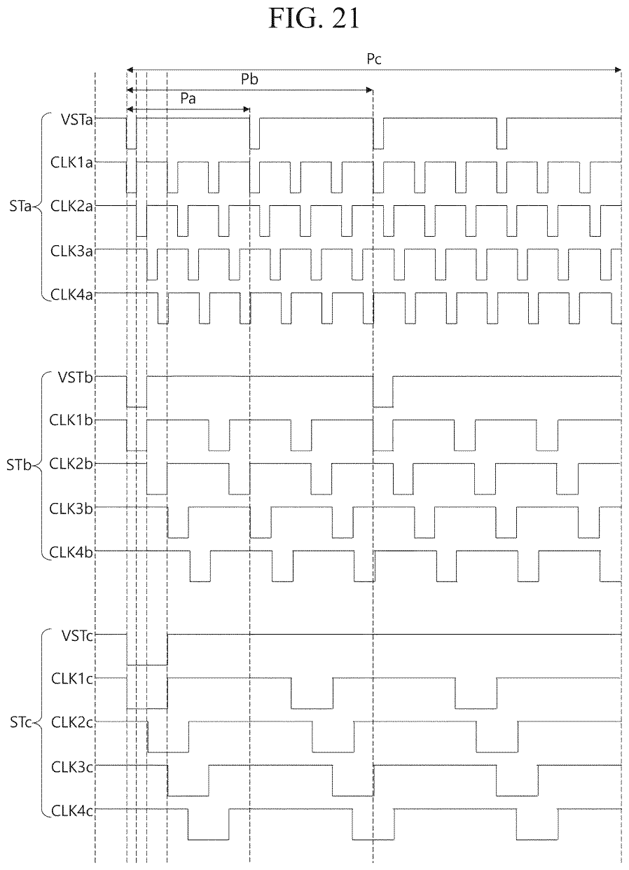

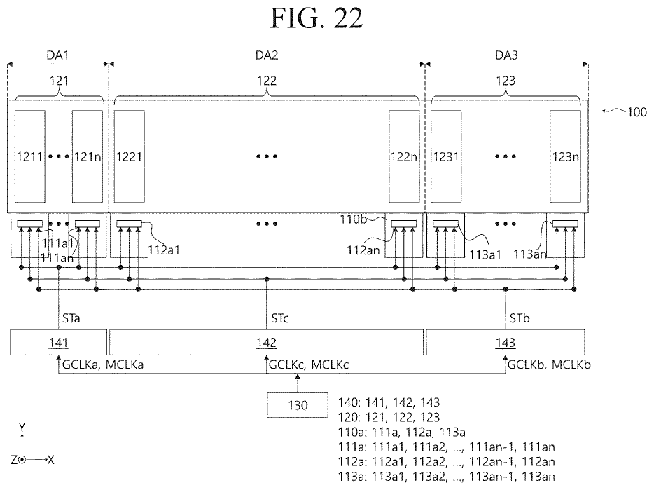

FIG. 22 is a block diagram showing a display device according to a third implementation of the present specification. FIG. 23 is a block diagram showing a signal transmission path in the display device according to the third implementation of the present specification.

Referring to FIG. 22, an a-th output signal STa may include a start signal VSTa and clock signals CLK1a, CLK2a, CLK3a, and CLK4a input to a first gate driver 121. A b-th output signal STb may include a start signal VSTb and clock signals CLK1b, CLK2b, CLK3b, and CLK4b input to a third gate driver 123. A c-th output signal STc may include a start signal VSTc and clock signals CLK1c, CLK2c, CLK3c, CLK4c input to a second gate driver 122.

In the display device according to one implementation, a first level shifter 141 may be connected to the first gate driver 121, the second gate driver 122, and the third gate driver 123. A second level shifter 142 may be connected to the first gate driver 121, the second gate driver 122, and the third gate driver 123. A third level shifter 143 may be connected to the first gate driver 121, the second gate driver 122, and the third gate driver 123.

For example, the first level shifter 141 may be connected to a first source drive IC 111a, a second source drive IC 112a, and a third source drive IC 113a. The second level shifter 142 may be connected to the first source drive IC 111a, the second source drive IC 112a, and the third source drive IC 113a. The third level shifter 143 may be connected to the first source drive IC 111a, the second source drive IC 112a, and the third source drive IC 113a. The first source drive IC 111a may be connected to the first gate driver 121. The second source drive IC 112a may be connected to the second gate driver 122. The third source drive IC 113a may be connected to the third gate driver 123.

A plurality of source drive ICs 110a may receive a plurality of output signals from a plurality of level shifters 140. A COF on which each of the plurality of source drive ICs 110a is mounted may include a multiplexer. The multiplexer which receives a plurality of signals may transmit output signals required for each of the plurality of gate drivers 120.

Referring to FIG. 23, the COF on which a 1-1 source drive IC 111a1 is mounted may include a 1-1 multiplexer MUX11. The 1-1 source drive IC 111a1 may include the 1-1 multiplexer MUX11.

The 1-1 multiplexer MUX11 may receive the a-th output signal STa from the first level shifter 141, the b-th output signal STb from the second level shifter 142, and the c-th output signal STc from the third level shifter 143. The 1-1 multiplexer MUX11 which receives each output signal may transmit an output signal corresponding to a frame frequency required for driving a first display region DA1 including a 1-1 gate driver 1211 connected to the 1-1 source drive IC 111a1. For example, the 1-1 multiplexer MUX11 may transmit the a-th output signal STa to the 1-1 gate driver 1211 in response to a multiplexer control signal CTS.

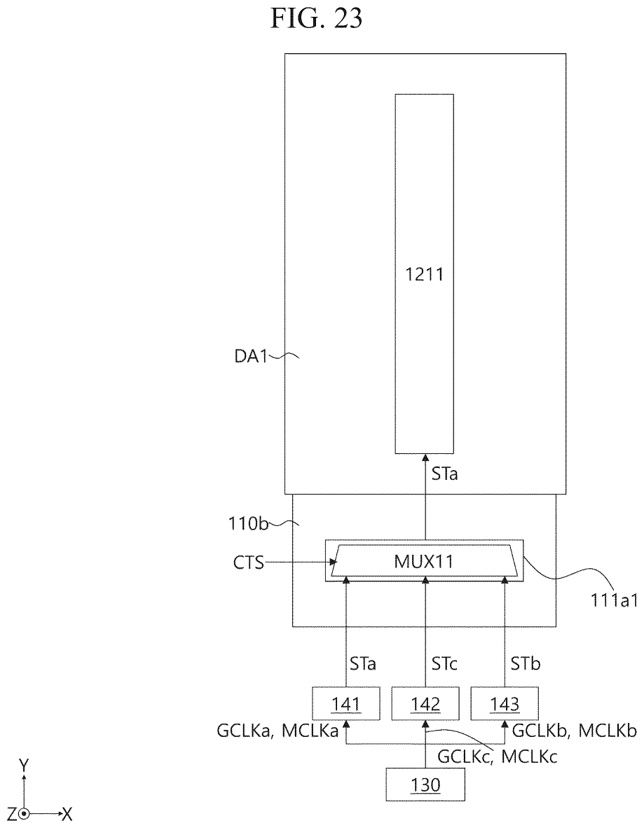

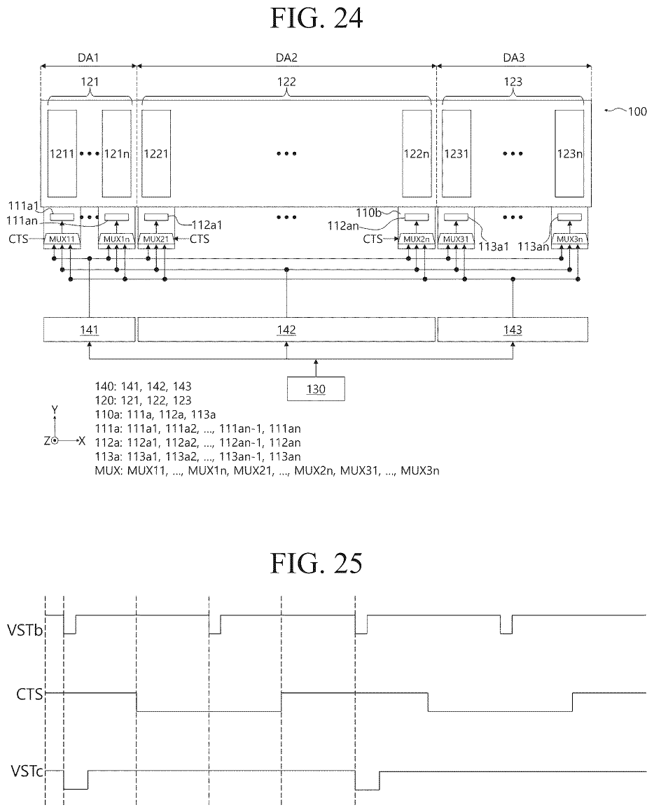

FIG. 24 is a block diagram showing a display device according to a fourth implementation of the present specification. FIG. 25 is a waveform diagram showing exemplary multiplexer control and output signals of the present specification.

Referring to FIGS. 24 and 25, a plurality of source drive ICs 110a may include a plurality of multiplexers, respectively. For example, a first source drive IC 111a, a second source drive IC 112a, and a third source drive IC 113a may include a first multiplexer, a second multiplexer, and a third multiplexer, respectively. A 1-1 source drive IC 111a1, a 1-2 source drive IC 111a2, . . . , and the 1-n source drive IC 111an may include a 1-1 multiplexer MUX11, a 1-2 multiplexer MUX12, . . . , and a 1-n multiplexer MUX1n, respectively. A 2-1 source drive IC 112a1, a 2-2 source drive IC 112a2, . . . , and a 2-n source drive IC 112an may include a 2-1 multiplexer MUX21, a 2-2 multiplexer MUX22, . . . , and a 2-n multiplexer MUX2n, respectively. A 3-1 source drive IC 113a1, a 3-2 source drive IC 113a2, . . . , and a 3-n source drive IC 113an may include a 3-1 multiplexer MUX31, a 3-2 multiplexer MUX32, . . . , and a 3-n multiplexer MUX3n, respectively.

Each of the plurality of multiplexers MUX may receive an a-th output signal STa from a first level shifter 141, a b-th output signal STb from a second level shifter 142, and a c-th output signal STc from a third level shifter 143. As described above, each of the plurality of multiplexers MUX may transmit an output signal corresponding to a frame frequency required for driving a display region including a gate driver connected to the multiplexer in response to a multiplexer control signal CTS. For example, the 1-1 multiplexer MUX11 may transmit the a-th output signal STa to a 1-1 gate driver 1211 in response to the multiplexer control signal CTS.

In the present specification, a plurality of level shifters 140 may be formed based on the number of regions which are divided and driven. Accordingly, a display device which adjusts the frame frequency according to each divided driving display region may be provided. According to the implementation, a large size display device which may have reduced power consumption and may operate at low power may be provided.

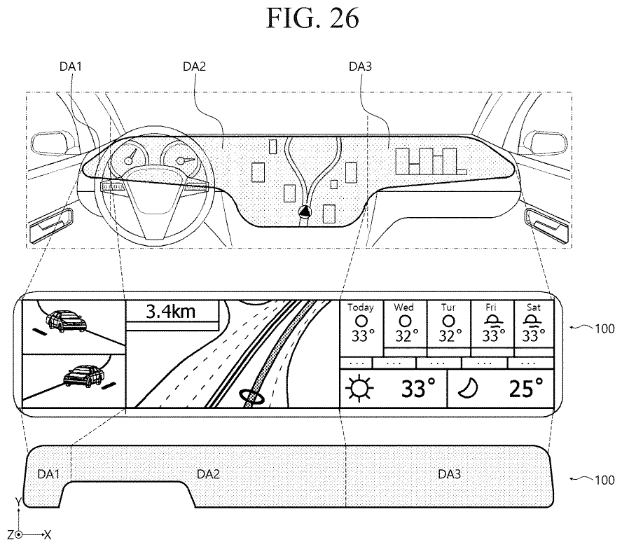

FIG. 26 is a view showing an example in which the display device according to the implementation of the present specification is applied to an infotainment system of a vehicle. FIG. 27 is a waveform diagram showing the frame frequency for each display region.

Referring to FIG. 26, in the example applied to the infotainment system of the vehicle, additional service images such as a side mirror image, a cluster or navigation image, a weather information or multimedia image, and the like may be simultaneously displayed on a screen of the display device according to the implementation of the present specification.

The side mirror image may be reproduced at a high speed with a high frame frequency to secure driving stability. The cluster or navigation image may have a relatively long update period. Accordingly, the cluster or navigation image may be reproduced at a low speed and power consumption may be reduced by a low speed driving method. An update period of the multimedia image may be shorter than that of the cluster or navigation image and longer than that of the side mirror image. Accordingly, the multimedia image may be reproduced at an intermediate speed between the high speed and the low speed.

The display region of the display device according to the implementation may be divided and driven into a first display region DA1 where a first image (the side mirror image) is displayed, a second display region DA2 where a second image (the cluster or navigation image) is displayed, and a third display region DA3 where a third image (the weather information or multimedia image) is displayed.

In one example, the first display region DA1 may be a high-speed driving region where an image is updated at a frame frequency of 120 Hz. The second display region DA2 may be a low-speed driving region where an image is updated at a frame frequency of 15 Hz to 30 Hz. The third display region DA3 may be a medium-speed driving region where an image is updated at a frame frequency of 60 Hz.

Referring to FIG. 27, FR1 to FR120 may be frame numbers. FR1 to FR120 may represent first to 120th frames of the first display region DA1 driven at the frame frequency of 120 Hz. FR1 to FR60 may represent first to 60th frames of the third display region DA3 driven at the frame frequency of 60 Hz. FR1 to FR30 may represent first to 30th frames of the second display region DA2 driven at the frame frequency of 30 Hz. A plurality of application images or a plurality of content images may be simultaneously divided and displayed on the screen.

According to the present specification, a display device which adjusts a frame frequency according to each divided driving region can be provided.

According to the present specification, power consumption of a display device divided and driven in a horizontal direction can be reduced.

The implementations disclosed in the present specification are not intended to limit the technical spirit of the present specification, but intended to describe the same, and the scope of the technical spirit of the present specification is not limited by these implementations.

Accordingly, the implementations disclosed in the present specification are not intended to limit the technical spirit of the present specification but illustrate it, and the scope of the technical spirit of the present specification is not limited by these implementations.

Accordingly, the above-described implementations should be understood as exemplary in all aspects and not restrictive.

The scope of the present disclosure should be interpreted by the claims, and it should be interpreted that all technical ideas within the equivalent range are included in the scope of the present disclosure.

What is claimed is:

1. A display device comprising:
a display panel including a plurality of gate drivers and a plurality of pixels disposed in a matrix form;
a plurality of level shifters connected to the plurality of gate drivers; and
a timing controller connected to the plurality of level shifters,
wherein the plurality of gate drivers are disposed between the plurality of pixels.

2. The display device of claim 1, wherein the display panel includes a display region including a first display region and a second display region, and
the plurality of gate drivers include a first gate driver disposed in the first display region and a second gate driver disposed in the second display region.

3. The display device of claim 2, wherein a pulse width of a start signal input to the first gate driver is different from a pulse width of a start signal input to the second gate driver.

4. The display device of claim 2, wherein a first frame frequency at which the first display region is driven is different from a second frame frequency at which the second display region is driven.

5. The display device of claim 2, wherein the plurality of level shifters include a first level shifter connected to the first gate driver and a second level shifter connected to the second gate driver.

6. The display device of claim 5, wherein the first level shifter is connected to the second gate driver, and
the second level shifter is connected to the first gate driver.

7. The display device of claim 5, further comprising a plurality of source drive integrated circuits (ICs) disposed between the plurality of level shifters and the plurality of gate drivers,
wherein each source drive IC in the plurality of source drive ICs is connected to a respective level shifter in the plurality of level shifters and a respective gate driver in the plurality of gate drivers.

8. The display device of claim 7, wherein the plurality of source drive ICs include a first source drive IC disposed between the first level shifter and the first gate driver, and a second source drive IC disposed between the second level shifter and the second gate driver.

9. The display device of claim 8, wherein the first source drive IC is connected to the first level shifter and the first gate driver, and
the second source drive IC is connected to the second level shifter and the second gate driver.

10. The display device of claim 9, wherein the first source drive IC is connected to the second level shifter, and
the second source drive IC is connected to the first level shifter.

11. The display device of claim 9, further comprising:
a first multiplexer connected to the first level shifter, the second level shifter, and the first source drive IC; and
a second multiplexer connected to the second level shifter, the first level shifter, and the second source drive IC.

12. The display device of claim 2, wherein the display region further includes a third display region, and
the plurality of gate drivers further include a third gate driver disposed in the third display region.

13. The display device of claim 12, wherein a first frame frequency at which the first display region is driven, a second frame frequency at which the second display region is driven, and a third frame frequency at which the third display region is driven are all different from each other.

14. The display device of claim 12, wherein the plurality of level shifters include a first level shifter connected to the first gate driver, a second level shifter connected to the second gate driver, and a third level shifter connected to the third gate driver.

15. The display device of claim 14, wherein the first level shifter is connected to the second gate driver and the third gate driver,
the second level shifter is connected to the first gate driver and the third gate driver, and
the third level shifter is connected to the first gate driver and the second gate driver.

16. The display device of claim 14, further comprising a plurality of source drive ICs disposed between the plurality of level shifters and the plurality of gate drivers,
wherein each source drive IC in the plurality of source drive ICs is connected to a respective level shifter in the plurality of level shifters and a respective gate driver in the plurality of gate drivers.

17. The display device of claim 16, wherein the plurality of source drive ICs include a first source drive IC disposed between the first level shifter and the first gate driver, a second source drive IC disposed between the second level shifter and the second gate driver, and a third source drive IC disposed between the third level shifter and the third gate driver.

18. The display device of claim 17, wherein the first source drive IC is connected to the first level shifter and the first gate driver,
the second source drive IC is connected to the second level shifter and the second gate driver, and
the third source drive IC is connected to the third level shifter and the third gate driver.

19. The display device of claim 18, wherein the first source drive IC is connected to the second level shifter and the third level shifter,
the second source drive IC is connected to the first level shifter and the third level shifter, and
the third source drive IC is connected to the first level shifter and the second level shifter.

20. The display device of claim 18, further comprising:
a first multiplexer connected to the first level shifter, the second level shifter, the third level shifter, and the first source drive IC;
a second multiplexer connected to the second level shifter, the first level shifter, the third level shifter, and the second source drive IC; and
a third multiplexer connected to the third level shifter, the first level shifter, the second level shifter, and the third source drive IC.
